(19) United States
(12) Patent Application Publication
(10) Pub. No.: US 2024/0376665 A1
(43) Pub. Date: Nov. 14, 2024

(54) WATER-REPELLENT POLYACRYLONITRILE-BASED SYNTHETIC HAIR FIBER, METHOD FOR PRODUCING SAME, AND HEADDRESS PRODUCT

(71) Applicant: KANEKA CORPORATION, Osaka (JP)

(72) Inventors: Takaaki Kobashi, Hyogo (JP); Nobutaka Taoka, Hyogo (JP); Takeshi Tanaka, Hyogo (JP)

(73) Assignee: KANEKA CORPORATION, Osaka (JP)

(21) Appl. No.: 18/780,200

(22) Filed: Jul. 22, 2024

Related U.S. Application Data
(63) Continuation of application No. PCT/JP2023/012982, filed on Mar. 29, 2023.

(30) Foreign Application Priority Data
Mar. 30, 2022 (JP) 2022-057658
Mar. 30, 2022 (JP) 2022-057659
Mar. 30, 2022 (JP) 2022-057660
Jan. 31, 2023 (JP) 2023-013142
Jan. 31, 2023 (JP) 2023-013143
Jan. 31, 2023 (JP) 2023-013144

(51) Int. Cl. D06M 15/507; D01D 5/06; D01D 11/06; D01F 1/04; D01F 6/18; D06M 13/463; D06M 13/467; D06M 15/564; D06M 15/643; D06M 15/65

(52) U.S. Cl. CPC D06M 15/507; D01D 5/06; D01D 11/06; D01F 6/18; D06M 13/463; D06M 13/467; D06M 15/564; D06M 15/6436; D06M 15/65; D01F 1/04; D10B 2321/10; D10B 2401/021; D10B 2401/16; D10B 2503/08

(57) ABSTRACT

A water-repellent polyacrylonitrile-based synthetic hair fiber contains a polyacrylonitrile-based synthetic fiber (A) and a water repellent (B) attached to the polyacrylonitrile-based synthetic fiber (A). The water repellent (B) does not have a fluoro group and contains at least one selected from the group consisting of a dendrimer-based water repellent (B-1), an alkyl urethane-based water repellent (B-2), and condensation reaction type polydimethylsiloxane (B-3). The dendrimer-based water repellent (B-1) has an ester and/or urethane bond. The alkyl urethane-based water repellent (B-2) has a long-chain hydrocarbon side chain and is non-dendrimer-based. The condensation reaction type polydimethylsiloxane (B-3) has, at both terminals, a hydroxyl group, an organic group having a hydroxyl group, or an organic group capable of generating a hydroxyl group. The amount of the water repellent (B) attached is between 0.05 mass % and 1.0 mass % both inclusive with respect to a total mass of the polyacrylonitrile-based synthetic fiber (A).

### TECHNICAL FIELD

One or more embodiments of the present invention relate to a water-repellent polyacrylonitrile-based synthetic hair fiber, a method for producing the same, and a headdress product.

### BACKGROUND

In the related art, a fluorine-based water repellent having a fluorine-containing group has been known, and a fiber product whose surface is provided with a water repellency by treating the fiber product or the like with such a fluorine-based water repellent has been known. Such a fluorine-based water repellent is generally produced by polymerizing or copolymerizing a monomer having a fluoroalkyl group. The fiber product treated with the fluorine-based water repellent exhibits a superior water repellency, but the monomer having a fluoroalkyl group is less likely to be decomposed, and thus places a large burden on the environment. Under such circumstances, in recent years, studies have been made on a non-fluorine-based water repellent containing no fluorine. For example, Patent Document 1 describes that a fiber product obtained by treating a nylon cloth or a polyester cloth with a specific non-fluorine-based water repellent has a sufficient water repellency and a durable water repellency.

### PATENT DOCUMENT

Patent Document 1: Japanese Unexamined Patent Application, Publication No. 2017-210704

A polyacrylonitrile-based synthetic fiber is used as a synthetic hair fiber because it has texture similar to human hair, and there is a demand for providing a water repellency to the polyacrylonitrile-based synthetic hair fiber as well. Therefore, in order to achieve such a purpose, a method of treatment with the non-fluorine-based water repellent is considered. However, when the polyacrylonitrile-based synthetic fiber is treated with the non-fluorine-based water repellent, the water repellency is improved, but the texture inherent to the polyacrylonitrile-based synthetic fiber is impaired.

### SUMMARY

One or more embodiments of the present invention have been made in view of the above, and provide a polyacrylonitrile-based synthetic hair fiber that is superior in water repellency and texture, a method for producing the fiber, and a headdress product containing the fiber.

The present inventors have found that the above can be addressed by using a specific non-fluorine-based water repellent and intensively studying an amount of the non-fluorine-based water repellent attached, and have completed one or more embodiments of the present invention.

Aspects of one or more embodiments of the present invention relate to a water-repellent polyacrylonitrile-based synthetic hair fiber, a method for producing the fiber, and a headdress product containing the fiber.

[1] A water-repellent polyacrylonitrile-based synthetic hair fiber including: a polyacrylonitrile-based synthetic fiber (A); and
a water repellent (B) attached to the polyacrylonitrile-based synthetic fiber (A),
the water repellent (B) not having a fluoro group,
the water repellent (B) containing at least one selected from the group consisting of a dendrimer-based water repellent (B-1), an alkyl urethane-based water repellent (B-2), and condensation reaction type polydimethylsiloxane (B-3),
the dendrimer-based water repellent (B-1) having an ester and/or urethane bond,
the alkyl urethane-based water repellent (B-2) having a long-chain hydrocarbon side chain and being non-dendrimer-based,
the condensation reaction type polydimethylsiloxane (B-3) having, at both terminals, a hydroxy group, an organic group having a hydroxy group, or an organic group capable of generating a hydroxy group,
an amount of the water repellent (B) attached being 0.05 mass % or more and 1.0 mass % or less with respect to a total mass of the polyacrylonitrile-based synthetic fiber (A).

[2] The water-repellent polyacrylonitrile-based synthetic hair fiber according to [1], further including: a modified silicone (C) attached to the polyacrylonitrile-based synthetic fiber (A),
the modified silicone (C) being a dimethylsiloxane polymer substituted with an epoxy group and/or an amino group,
an amount of the modified silicone (C) attached being 0.01 mass % or more and 0.5 mass % or less with respect to the total mass of the polyacrylonitrile-based synthetic fiber (A).

[3] The water-repellent polyacrylonitrile-based synthetic hair fiber according to [1] or [2], in which the dendrimer-based water repellent (B-1) has a hydrophobic terminal residue.

[4] The water-repellent polyacrylonitrile-based synthetic hair fiber according to any one of [1] to [3], in which the alkyl urethane-based water repellent (B-2) has a skeleton derived from sorbitan.

[5] The water-repellent polyacrylonitrile-based synthetic hair fiber according to any one of [1] to [4], further including: an ionic antistatic agent (D1) and/or a nonionic antistatic agent (D2) as an antistatic agent (D) attached to the polyacrylonitrile-based synthetic fiber (A),
an amount of the antistatic agent (D) attached being 0.05 mass % or more and 0.3 mass % or less with respect to the total mass of the polyacrylonitrile-based synthetic fiber (A).

[6] The water-repellent polyacrylonitrile-based synthetic hair fiber according to any one of [1] to [5], in which a mass ratio of an amount of the dendrimer-based water repellent (B-1) attached to an amount of a modified silicone (C) attached is (B-1):(C)=1:0.03 or more and 1:0.3 or less.

[7] The water-repellent polyacrylonitrile-based synthetic hair fiber according to any one of [1] to [6], in which a mass ratio of an amount of the alkyl urethane-based water repellent (B-2) attached to an amount of a modified silicone (C) attached is (B-2):(C)=1:0.03 or more and 1:0.5 or less.

[8] The water-repellent polyacrylonitrile-based synthetic hair fiber according to [5], in which a mass ratio of the amount of the water repellent (B) attached to the amount of the antistatic agent (D) attached is (B):(D)=1:0.15 or more and 1:0.7 or less.

[9] The water-repellent polyacrylonitrile-based synthetic hair fiber according to [5], in which a mass ratio of an amount of the dendrimer-based water repellent (B-1) attached to an amount of a modified silicone (C) attached is (B-1):(C)=1:0.03 or more and 1:0.3 or less, and
a mass ratio of the amount of the dendrimer-based water repellent (B-1) attached to the amount of the antistatic agent (D) attached is (B-1):(D)=1:0.15 or more and 1:0.7 or less.

[10] The water-repellent polyacrylonitrile-based synthetic hair fiber according to [5], in which a mass ratio of an amount of the alkyl urethane-based water repellent (B-2) attached to an amount of a modified silicone (C) attached is (B-2):(C)=1:0.03 or more and 1:0.5 or less, and
a mass ratio of the amount of the alkyl urethane-based water repellent (B-2) attached to the amount of the antistatic agent (D) attached is (B-2):(D)=1:0.15 or more and 1:0.7 or less.

[11] The water-repellent polyacrylonitrile-based synthetic hair fiber according to any one of [1] to [10], in which a single fiber fineness is 1 dtex or more and 100 dtex or less.

[12] A method for producing the water-repellent polyacrylonitrile-based synthetic hair fiber according to any one of [1] to [11], the method including:
obtaining a coagulated yarn by wet-spinning a spinning solution containing an acrylonitrile-based polymer; and bringing a yarn to be treated before drying into contact with an oil agent containing the water repellent (B).

[13] A method for producing the water-repellent polyacrylonitrile-based synthetic hair fiber according to any one of [1] to [11], the method including:
bringing a dried polyacrylonitrile-based synthetic fiber (A) into contact with an oil agent containing the water repellent (B); and drying a thread after the contact treatment.

[14] A headdress product including: the water-repellent polyacrylonitrile-based synthetic hair fiber according to any one of [1] to [11].

[15] The headdress product according to [14], in which the headdress product is at least one selected from the group consisting of a hair wig, a hairpiece, a weaving, a hair extension, a braid hair, a hair accessory, and a doll hair. Effects of the Invention

According to one or more embodiments of the present invention, it is possible to provide a polyacrylonitrile-based synthetic hair fiber that is superior in water repellency and texture, a method for producing the fiber, and a headdress product containing the fiber.

### PREFERRED MODE FOR CARRYING OUT THE INVENTION

### <<Water-Repellent Polyacrylonitrile-Based Synthetic Hair Fiber>>

A water-repellent polyacrylonitrile-based synthetic hair fiber includes a polyacrylonitrile-based synthetic fiber (A).

In the water-repellent polyacrylonitrile-based synthetic hair fiber, a water repellent (B) to be described below is attached to the polyacrylonitrile-based synthetic fiber (A), and
an amount of the water repellent (B) attached is 0.05 mass % or more and 1.0 mass % or less with respect to a total mass of the polyacrylonitrile-based synthetic fiber (A).

More specifically, in the water-repellent polyacrylonitrile-based synthetic hair fiber, the water repellent (B) is attached to a surface of the polyacrylonitrile-based synthetic fiber (A) to form a film.

Due to the water repellent (B) being attached to the polyacrylonitrile-based synthetic fiber (A) in a specific amount, the water-repellent polyacrylonitrile-based synthetic hair fiber also exhibits an effect of being superior in water repellency and texture when no modified silicone (C) to be described later is attached to the polyacrylonitrile-based synthetic fiber (A).

Hereinafter, essential or optional components contained in the water-repellent polyacrylonitrile-based synthetic hair fiber will be described.

### (Polyacrylonitrile-Based Synthetic Fiber (A))

An acrylonitrile-based polymer constituting the polyacrylonitrile-based synthetic fiber (A) is not particularly limited as long as it contains 25 mass % or more of a constituent unit derived from acrylonitrile, and for example, an acrylonitrile-based polymer containing 25 mass % to 100 mass % of a constituent unit derived from acrylonitrile and 0 mass % to 75 mass % of a constituent unit derived from another monomer can be used. The acrylonitrile-based polymer may contain 95 mass % or less of the constituent unit derived from acrylonitrile and 5 mass % or more of the constituent unit derived from the other monomer, may contain 90 mass % or less of the constituent unit derived from acrylonitrile and 10 mass % or more of the constituent unit derived from the other monomer, and may contain 30 mass % to less than 85 mass % of the constituent unit derived from acrylonitrile and more than 15 mass % and 70 mass % or less of the constituent unit derived from the other monomer.

The other monomer is not particularly limited as long as it is copolymerizable with acrylonitrile, and examples thereof include unsaturated carboxylic acids such as acrylic acid and methacrylic acid and salts thereof, acrylate esters such as methyl acrylate, methacrylic esters such as methyl methacrylate, esters of unsaturated carboxylic acids such as glycidyl methacrylate, vinyl esters such as vinyl acetate and vinyl butyrate, halogen-containing monomers, and sulfonic acid group-containing monomers. These may be used alone or may be used in combination of two or more thereof.

The acrylonitrile-based polymer may contain 30 mass % to 80 mass % of the constituent unit derived from acrylonitrile, 20 mass % to 70 mass % of a constituent unit derived from a halogen-containing monomer, and 0 mass % to 5 mass % of a constituent unit derived from a sulfonic acid group-containing monomer, from the viewpoint of heat resistance, flame resistance, and dyeability. The acrylonitrile-based polymer may contain 35 mass % to 75 mass % of the constituent unit derived from acrylonitrile, 25 mass % to 65 mass % of the constituent unit derived from the halogen-containing monomer, and 0 mass % to 5 mass % of the constituent unit derived from the sulfonic acid group-containing monomer, and may contain 35 mass % to 75 mass % of the constituent unit derived from acrylonitrile, 24.5 mass % to 64.5 mass % of the constituent unit derived from the halogen-containing monomer, and 0.5 mass % to 5 mass % of the constituent unit derived from the sulfonic acid group-containing monomer.

Examples of the halogen-containing monomer include halogen-containing vinyl monomers such as vinyl chloride and vinyl bromide, and halogen-containing vinylidene monomers such as vinylidene chloride and vinylidene bromide. The halogen-containing monomer may be used alone or may be used in combination of two or more thereof. The halogen-containing monomer may contain at least one selected from the group consisting of vinyl chloride and vinylidene chloride, and may contain vinyl chloride from the viewpoint of texture.

The sulfonic acid group-containing monomer is not particularly limited, and examples thereof include allylsulfonic acid, methallylsulfonic acid, styrenesulfonic acid, isoprenesulfonic acid, 2-acrylamido-2-methylpropanesulfonic acid, metal salts such as sodium salts thereof, and amine salts. The sulfonic acid group-containing monomer may be used alone or may be used in combination of two or more thereof.

A single fiber fineness of the polyacrylonitrile-based synthetic fiber (A) is not particularly limited, and may be, for example, 1 dtex or more and 100 dtex or less, and the single fiber fineness may be 10 dtex or more and 90 dtex or less, 20 dtex or more and 80 dtex or less, 30 dtex or more and 70 dtex or less, or 35 dtex or more and 65 dtex or less, from the viewpoint of suitable use as synthetic hair.

A method for producing the polyacrylonitrile-based synthetic fiber (A) is not particularly limited, and the polyacrylonitrile-based synthetic fiber (A) can be produced by using, for example, a wet spinning method. The wet spinning method is a method in which a spinning raw solution made of the acrylonitrile-based polymer is extruded from a spinning nozzle into a coagulation bath and coagulated in the coagulation bath to form a thread. In addition, the wet spinning method may include any one of a water washing step, a drying step, a stretching step, and a thermal relaxation step in addition to the coagulation step.

The polyacrylonitrile-based synthetic fiber (A) may be produced by using the above-described method, or a commercially available polyacrylonitrile-based synthetic fiber may be obtained. Examples of the commercially available product of the polyacrylonitrile-based synthetic fiber (A) include “AFRELLE” and “SYC” manufactured by Kaneka Corporation.

### (Water Repellent (B))

The water repellent (B) contains at least one selected from the group consisting of a dendrimer-based water repellent (B-1), an alkyl urethane-based water repellent (B-2), and condensation reaction type polydimethylsiloxane (B-3). The water repellent (B) is used as a non-fluorine-based water repellent. Therefore, the water repellent (B) does not have a fluoro group.

### [Dendrimer-Based Water Repellent (B-1)]

The dendrimer-based water repellent (B-1) contains a dendritic high molecular compound having a radial structure regularly branched from a center thereof.

The dendrimer-based water repellent (B-1) has an ester and/or urethane bond in the branched structure. The dendrimer-based water repellent (B-1) has a hydrophobic terminal residue in the branched structure. It is presumed that the hydrophobic terminal residue imparts water repellency to the dendrimer-based water repellent (B-1). The hydrophobic terminal residue may be, for example, an alkyl group having 12 to 26 carbon atoms.

The molecular weight of the dendrimer-based water repellent (B-1) may be 1,000 or more and 100,000 or less, or 1,000 or more and 30,000 or less, from the viewpoint of stability in a solution and ease of synthesis.

Examples of a commercially available product of the dendrimer-based water repellent (B-1) include “RUCO-DRY ECO PSS” and “RUCO-DRY ECO PLUS” manufactured by RUDOLF GmbH.

### [Alkyl Urethane-Based Water Repellent (B-2)]

The alkyl urethane-based water repellent (B-2) is a polymer having, in a molecule, a urethane bond derived from a reaction between a polyol derivative and a polyisocyanate and a long-chain hydrocarbon side chain. The long-chain hydrocarbon side chain may be a side chain having a polyol derivative and/or a polyisocyanate. The long-chain hydrocarbon side chain may be, for example, a straight-chain alkyl group having 12 to 24 carbon atoms, or a straight-chain alkyl group having 16 to 22 carbon atoms.

The polyol derivative is not particularly limited as long as it is a known compound, and examples thereof include a polyether polyol, a low-molecular polyol, a polyester polyol, a polycarbonate polyol, a polybutadiene glycol, a glycol, and an acrylic polyol, which may have one or more of the long-chain hydrocarbon side chains. These may be used alone or may be used in combination of two or more thereof. Of these, the preferred is a sorbitan derivative.

The polyisocyanate is not particularly limited as long as it is a known compound, and examples thereof include an aliphatic polyisocyanate, an alicyclic polyisocyanate, an araliphatic polyisocyanate, an aromatic polyisocyanate, and a derivative of the polyisocyanate, which may have the long-chain hydrocarbon side chain. These may be used alone or may be used in combination of two or more thereof.

In addition, the alkyl urethane-based water repellent (B-2) may have a skeleton derived from sorbitan.

The alkyl urethane-based water repellent (B-2) is non-dendrimer-based.

Examples of a commercially available product of the alkyl urethane-based water repellent (B-2) include “ZELAN R3” manufactured by HUNTSMAN.

### [Condensation Reaction Type Polydimethylsiloxane (B-3)]

The condensation reaction type polydimethylsiloxane (B-3) has, at both terminals, a hydroxy group, an organic group having a hydroxy group, or an organic group capable of generating a hydroxy group.

Examples of the organic group having a hydroxy group include an alkanol group (—ROH) such as a carbinol group and a polyether alkyl group (—R—X—OH). Here, R of the alkanol group and the polyether alkyl group represents an alkyl group having 1 to 3 carbon atoms, and X represents a polyalkylene oxide chain such as a polyethylene oxide chain and a polypropylene oxide chain.

Examples of the organic group capable of generating a hydroxy group include alkoxy groups such as a methoxy group, an ethoxy group, and a propyloxy group.

Examples of a commercially available product of the condensation reaction type polydimethylsiloxane (B-3) include “Rikenpalan SG-54” manufactured by MIKIRIKEN INDUSTRIAL CO., LTD.

The amount of the water repellent (B) attached may be 0.05 mass % or more and 1.0 mass % or less, 0.08 mass % or more and 0.75 mass % or less, or 0.1 mass % or more and 0.4 mass % or less with respect to the total mass of the polyacrylonitrile-based synthetic fiber (A).

An amount of the dendrimer-based water repellent (B-1) attached may be 0.05 mass % or more and 1.0 mass % or less, 0.08 mass % or more and 0.75 mass % or less, or 0.1 mass % or more and 0.4 mass % or less with respect to the total mass of the polyacrylonitrile-based synthetic fiber (A), from the viewpoint that the polyacrylonitrile-based synthetic hair fiber is superior in water repellency and texture.

An amount of the alkyl urethane-based water repellent (B-2) attached and an amount of the condensation reaction type polydimethylsiloxane (B-3) attached may be 0.05 mass % or more and 1.0 mass % or less, 0.08 mass % or more and 0.75 mass % or less, or 0.1 mass % or more and 0.6 mass % or less with respect to the total mass of the polyacrylonitrile-based synthetic fiber (A), from the viewpoint that the polyacrylonitrile-based synthetic hair fiber is superior in water repellency and texture.

### (Other Components)

The polyacrylonitrile-based synthetic hair fiber may contain components other than the polyacrylonitrile-based synthetic fiber (A) and the water repellent (B) (hereinafter also referred to as “other components”) as long as the effect of one or more embodiments of the present invention is not impaired. Examples of the other components include: a modified silicone; an antistatic agent; a gloss adjusting agent; a coloring agent such as an organic pigment, an inorganic pigment, and a dye; a light stabilizer; a thermal stabilizer; a fiber-converging agent; a deodorant; a fragrance; an insect repellent; an antibacterial agent; and a crosslinking agent.

### (Modified Silicone (C))

The modified silicone (C) is silicone having a substituent obtained by substituting any portion of a polydialkylsiloxane skeleton, preferably a polydimethylsiloxane skeleton (hereinafter, also collectively referred to as “polysiloxane”) of the silicone, and includes modified silicones obtained by modifying one terminal, both terminals, or a side chain of a straight-chain or branched polysiloxane, and a crosslinking type modified silicone obtained by crosslinking the polysiloxane.

The modified silicone (C) is not particularly limited, and examples thereof include epoxy-modified silicone, amino-modified silicone, mercapto-modified silicone, carboxyl-modified silicone, hydrogen-modified silicone, and methacrylic-modified silicone. These may be used alone or may be used in combination of two or more thereof.

Of these, the preferred are epoxy-modified silicone and amino-modified silicone, from the viewpoint that the polyacrylonitrile-based synthetic hair fiber is superior in water repellency and texture by using the dendrimer-based water repellent (B-1) or the alkyl urethane-based water repellent (B-2) in combination.

Examples of a commercially available product of the epoxy-modified silicone include “POLIN-MF-18T” manufactured by Shin-Etsu Chemical Co., Ltd. Examples of a commercially available product of the amino-modified silicone include “POLIN-MF-63” manufactured by Shin-Etsu Chemical Co., Ltd.

An amount of the modified silicone (C) attached may be 0.01 mass % or more and 0.5 mass % or less, 0.01 mass % or more and 0.3 mass % or less, or 0.02 mass % or more and 0.2 mass % or less with respect to the total mass of the polyacrylonitrile-based synthetic fiber (A), from the viewpoint that the polyacrylonitrile-based synthetic hair fiber is superior in water repellency and texture.

### (Antistatic Agent (D))

The antistatic agent (D) is not particularly limited, and examples thereof include an ionic antistatic agent (D1) and a nonionic antistatic agent (D2).

Examples of the ionic antistatic agent (D1) include anionic antistatic agents such as higher fatty acid salts, higher alcohol sulfate ester salts, sulfated oils, and sulfonates; cationic antistatic agents such as alkyl amine salts, quaternary ammonium salts, imidazolinium salts, and guanidine salts; and amphoteric antistatic agents such as amine oxide type and betaine type antistatic agents.

Examples of the nonionic antistatic agent (D2) include nonionic antistatic agents such as polyoxyethylene alkyl ether type, polyhydric alcohol fatty acid ester type, polyoxyethylene polyhydric alcohol fatty acid ester type, fatty acid alkanolamide type, polyoxyethylene alkyl amine type, and polyalkylene glycol.

The antistatic agent (D) may be used alone or may be used in combination of two or more thereof.

Of these, the preferred is the cationic antistatic agent (D1) and/or the nonionic antistatic agent (D2), from the viewpoint that the polyacrylonitrile-based synthetic hair fiber is superior in water repellency and texture.

An amount of the antistatic agent (D) attached can be appropriately selected within a range that does not impair one or more embodiments of the present invention, and may be 0.05 mass % or more and 0.3 mass % or less, or 0.10 mass % or more and 0.3 mass % or less with respect to the total mass of the polyacrylonitrile-based synthetic fiber (A), from the viewpoint of reducing static electricity.

When the dendrimer-based water repellent (B-1) is attached to the polyacrylonitrile-based synthetic fiber (A), the amount of the antistatic agent (D) attached can be appropriately selected within the range that does not impair one or more embodiments of the present invention, and may be 0.05 mass % or more and 0.3 mass % or less, or 0.10 mass % or more and 0.3 mass % or less with respect to the total mass of the polyacrylonitrile-based synthetic fiber (A), from the viewpoint of reducing the static electricity.

When the alkyl urethane-based water repellent (B-2) or the condensation reaction type polydimethylsiloxane (B-3) is attached to the polyacrylonitrile-based synthetic fiber (A), the amount of the antistatic agent (D) attached can be appropriately selected within the range that does not impair one or more embodiments of the present invention, and may be 0.05 mass % or more and 0.3 mass % or less, or 0.05 mass % or more and 0.2 mass % or less with respect to the total mass of the polyacrylonitrile-based synthetic fiber (A), from the viewpoint of reducing the static electricity.

A mass ratio of the amount of the dendrimer-based water repellent (B-1) attached to the amount of the modified silicone (C) attached may be (B-1):(C)=1:0.03 or more and 1:0.3 or less, 1:0.03 or more and 1:0.2 or less, or 1:0.03 or more and 1:0.1 or less, from the viewpoint of being superior in water repellency and texture.

A mass ratio of the amount of the alkyl urethane-based water repellent (B-2) attached to the amount of the modified silicone (C) attached may be (B-2):(C)=1:0.03 or more and 1:0.5 or less, 1:0.03 or more and 1:0.4 or less, or 1:0.04 or more and 1:0.3 or less, from the viewpoint of being superior in water repellency and texture.

A mass ratio of the amount of the water repellent (B) attached to the amount of the antistatic agent (D) attached may be (B):(D)=1:0.15 or more and 1:0.7 or less, 1:0.15 or more and 1:0.6 or less, or 1:0.2 or more and 1:0.5 or less, from the viewpoint of being superior in water repellency and reducing the static electricity.

When the static electricity is strongly generated, a trouble is likely to occur in a spinning step or a processing.

### <<Method 1 for Producing Water-Repellent Polyacrylonitrile-Based Synthetic Hair Fiber>>

One or more embodiments of a method for producing a water-repellent polyacrylonitrile-based synthetic hair fiber includes: obtaining a coagulated yarn by wet-spinning a spinning solution containing an acrylonitrile-based polymer; and bringing a yarn to be treated before drying into contact with an oil agent containing the water repellent (B).

According to the production method of one or more embodiments, as described above, it is possible to produce a water-repellent polyacrylonitrile-based synthetic hair fiber that is superior in water repellency and texture.

Hereinafter, a step of obtaining a coagulated yarn by wet-spinning a spinning solution containing an acrylonitrile-based polymer (hereinafter, also referred to as a “coagulation step”), a step of bringing a yarn to be treated before drying into contact with an oil agent containing the water repellent (B) (hereinafter, also referred to as a “contact step”), and any optional step will be described.

### <Coagulation Step>

### (Acrylonitrile-based Polymer)

The acrylonitrile-based polymer is a raw material for producing a yarn of the polyacrylonitrile-based synthetic fiber (A). The acrylonitrile-based polymer is the same as one or more embodiments of the acrylonitrile-based polymer described in the item of “polyacrylonitrile-based synthetic fiber (A)”.

### (Spinning Solution)

The spinning solution contains the acrylonitrile-based polymer and an organic solvent. The organic solvent is not particularly limited, and it is preferred to use a good solvent for an acrylonitrile-based polymer. Examples of the good solvent for an acrylonitrile-based polymer include dimethyl sulfoxide (DMSO), N, N-dimethylacetamide (DMAc), N, N-dimethylformamide (DMF), and acetone. Of these, acetone may be used from the viewpoint of versatility. In addition, dimethyl sulfoxide may be used from the viewpoint of high safety. The spinning solution may contain a small amount of water, for example, water of 1.5 mass % or more and 4.8 mass % or less. Accordingly, voids can be prevented from being formed.

### (Other Additives)

The spinning solution may contain other additives for improving fiber characteristics, if necessary, within a range that does not impair the effect of one or more embodiments of the present invention. Examples of the other additives include a gloss adjusting agent, an organic pigment, an inorganic pigment, a coloring agent such as a dye, and a stabilizer for improving light resistance or heat resistance.

### (Coagulation Step)

The coagulation step is a step of discharging the above-described spinning solution through a spinning nozzle into a coagulation solution (coagulation bath) and coagulating the same to form a thread (hereinafter, such a yarn is also referred to as a “coagulated yarn”). An operation of the coagulation step is not particularly limited, and may be, for example, a wet spinning method in which a spinning solution in a raw solution tank is directly discharged into a coagulation solution according to an ordinary method. In addition, the operation of the coagulation step may be a dry-wet spinning method in which the spinning solution is once discharged into the air from the spinning nozzle and then introduced into the coagulation solution.

A temperature of the spinning solution is not particularly limited as long as it is a temperature at which the spinning solution can be stably maintained without being changed over time in the raw solution tank, and for example, may usually be 40° C. or higher and 70° C. or lower.

A composition of the coagulation solution is not particularly limited, and for example, an aqueous solution of a good solvent such as acetone may be used. A concentration of the good solvent is not particularly limited, and may be, for example, 10 mass % or more and 70 mass % or less. If the concentration is less than 10 mass %, coagulation becomes rapid, a coagulation structure becomes coarse, and voids tend to be formed inside the fibers. A temperature of the coagulation solution is not particularly limited, and may be, for example, 5° C. or higher and 40° C. or lower.

The spinning nozzle can be appropriately used in accordance with an intended fiber cross section. The fiber cross section is not particularly limited, and may be any cross section such as circular, elliptical, and irregular shape. An amount of the spinning solution discharged from the spinning nozzle is not particularly limited, and may be, for example, 0.1 g/min or more as a single-hole discharge amount. A spinning speed of the spinning solution from the spinning nozzle is not particularly limited, and may be 2 m/min or more and 17 m/min or less from the viewpoint of industrial productivity.

The coagulated yarn (fiber) that passes through the coagulation solution is wound up by a winding roller via a feed roller, for example, according to an ordinary method, thereby obtaining an unstretched yarn. In addition, the coagulated yarn (fiber) may be continuously advanced to other steps without being wound up.

### (Other Steps)

The wet spinning may include steps other than the coagulation step (hereinafter, also referred to as “other steps”) as long as the effect of one or more embodiments of the present invention is not impaired. Examples of the other steps include a water washing step, a drying step, a stretching step, and a thermal relaxation treatment step.

Examples of the stretching step include a wet stretching step performed before the water washing step or after the water washing step and before the drying step, and a dry stretching step performed after the drying step.

An order of the steps is not particularly limited, and examples thereof include a method in which a wet stretching step, a water washing step, a drying step, a dry stretching step, and a thermal relaxation treatment step are sequentially performed after a coagulation step, and a method in which a water washing step, a wet stretching step, a drying step, a dry stretching step, and a thermal relaxation treatment step are sequentially performed after a coagulation step.

### (Wet Stretching Step)

The wet stretching step is a step of stretching the coagulated yarn in a stretching bath (hereinafter, also referred to as “primary stretching”). The stretching bath may be an aqueous solution having a lower concentration of a good solvent such as acetone than the coagulation bath. A temperature of the stretching bath may be 30° C. or higher, or 40° C. or higher. A stretching ratio is not particularly limited, and may be 1.5 times or more and 8 times or less, from the viewpoint of improving strength and productivity of the fibers. When the primary stretching is performed using a water bath, the wet stretching step may be performed after the water washing step to be described later, or the primary stretching and the water washing may be performed simultaneously.

### (Water Washing Step)

The water washing step is a step of removing a good solvent such as acetone attached to the yarn which is subjected to the coagulation step or the wet stretching step. In the water washing step, from the viewpoint of easily removing the good solvent, it is preferred to use hot water of 70° C. or higher, for example.

### (Drying Step)

The drying step is a step of densifying the yarn by drying the yarn. A drying temperature is not particularly limited, and may be, for example, 110° C. or higher and 190° C. or lower.

### (Dry Stretching Step)

The dry stretching step is a step of stretching the yarn under heating conditions (hereinafter, also referred to as “secondary stretching”). A stretching temperature is not particularly limited, and may be, for example, 110° C. or higher and 190° C. or lower. A stretching ratio is not particularly limited, and may be, for example, 1 time or more and 4 times or less, 1.5 times or more and 3.5 times or less, or 1.5 times or more and 3 times or less.

A total stretching ratio including wet stretching before drying may be 2 times or more and 10 times or less, 2 times or more and 8 times or less, 2 times or more and 6 times or less, or 2 times or more and 4 times or less.

### (Thermal Relaxation Treatment Step)

The thermal relaxation treatment step is a step of relaxing the yarn after being dry-stretched in a high temperature atmosphere. A relaxation rate is not particularly limited, and may be, for example, 5% or more, or 8% or more and 20% or less. The thermal relaxation treatment can be performed, for example, in a dry heat atmosphere of 140° C. or higher and 200° C. or lower or in a superheated steam atmosphere.

### <Contact Step>

(Yarn to be Treated before Drying)

The yarn to be treated before drying is a yarn that is not dried and therefore is not densified, and is a yarn that is brought into contact with an oil agent to be described later. The yarn to be treated includes, in addition to the coagulated yarn obtained by the wet spinning, yarns that are subjected to treatments other than the drying step, dry stretching step, and thermal relaxation treatment step described above. Specifically, the yarns to be treated include the coagulated yarn obtained by the wet spinning, a yarn that is wet-stretched, and a yarn that is washed with water. Of these, the preferred is the yarn that is washed with water from the viewpoint of preventing an organic solvent from being mixed into the oil agent.

### (Oil Agent)

The oil agent contains the above-described water repellent (B). The oil agent may be used as a mixed solution in which the water repellent (B) is dispersed or dissolved in water.

The oil agent may contain components other than the water repellent (B) and water (hereinafter, also referred to as “other components”) as long as the effect of one or more embodiments of the present invention is not impaired. Examples of the other components include: a modified silicone; an antistatic agent; a gloss adjusting agent; a coloring agent such as an organic pigment, an inorganic pigment, and a dye; a light stabilizer; a thermal stabilizer; a fiber-converging agent; a deodorant; a fragrance; an insect repellent; an antibacterial agent; and a crosslinking agent.

Of these, the modified silicone and the antistatic agent are the same as one or more embodiments described in the items of “(modified silicone (C))” and “(antistatic agent (D))”.

### (Contact Method)

A method of bringing a yarn to be treated into contact with an oil agent is not particularly limited, and examples thereof include an immersion method, a spraying method with a spray, a spread method with a shower, and an apply method. Of these, the preferred is the immersion method from the viewpoint of uniformly bringing the yarn to be treated into contact with each component contained in the oil agent.

A contact temperature is not particularly limited, and can be appropriately adjusted to 40° C. or higher and 90° C. or lower in accordance with a state of the yarn to be treated or an intended amount of attached.

A contact time is also not particularly limited, and can be appropriately adjusted to 1 second longer and 10 minutes or shorter in accordance with the state of the yarn to be treated or the intended amount of attached.

In one or more embodiments, it is preferred to dry the thread after the contact treatment and then dry-stretch the same. By going through such a step, it is possible to produce the water-repellent polyacrylonitrile-based synthetic hair fiber that is superior in the water repellency and the texture.

### <<Method 2 for Producing Water-Repellent Polyacrylonitrile-Based Synthetic Hair Fiber>>

One or more embodiments of a method for producing a water-repellent polyacrylonitrile-based synthetic hair fiber includes: bringing the dried polyacrylonitrile-based synthetic fiber (A) into contact with the oil agent containing the water repellent (B); and drying the thread after the contact treatment. According to the production method of one or more embodiments, as described above, it is possible to produce the water-repellent polyacrylonitrile-based synthetic hair fiber that is superior in the water repellency and the texture.

Hereinafter, a step of bringing the dried polyacrylonitrile-based synthetic fiber (A) into contact with the oil agent containing the water repellent (B) (hereinafter, also referred to as a “contact step”), a step of drying the thread after the contact treatment (hereinafter, also referred to as a “drying step”), and any step will be described.

### <Contact Step>

The polyacrylonitrile-based synthetic fiber (A) is the same as one or more embodiments described in the item of “polyacrylonitrile-based synthetic fiber (A)!”.

The dried polyacrylonitrile-based synthetic fiber (A) is obtained by, for example, drying the polyacrylonitrile-based synthetic fiber (A) at room temperature or higher and 190° C. or lower.

The oil agent containing the water repellent (B) is the same as one or more embodiments described in the item “!(oil agent)!”.

The method of bringing the dried polyacrylonitrile-based synthetic fiber (A) into contact with the oil agent is the same as one or more embodiments described in the item “(contact method)”.

However, in the present production method 2, the dried polyacrylonitrile-based synthetic fiber (A) is used as a raw material, and thus the components contained in the oil agent are less likely to be attached to the polyacrylonitrile-based synthetic fiber (A). Therefore, the contact time may be set to be longer than the contact time described in the <<method 1 for producing a polyacrylonitrile-based synthetic hair fiber>>.

### <Drying Step>

The drying step is a step of drying the thread of the polyacrylonitrile-based synthetic fiber (A) after the contact treatment to densify the yarn. A drying temperature is not particularly limited, and may be, for example, 110° C. or higher and 190° C. or lower.

### (Other Steps)

The present production method 2 may include a step other than the contact step and the drying step (hereinafter, also referred to as “other steps”) as long as the effect of one or more embodiments of the present invention is not impaired. Examples of the other step include a stretching step and a thermal relaxation treatment step. The stretching step and the thermal relaxation treatment step are the same as one or more embodiments described in the items “(stretching step)” and “(thermal relaxation treatment step)”.

### <<Headdress Product>>

The headdress product contains the above-described water-repellent polyacrylonitrile-based synthetic hair fiber.

The headdress product is not particularly limited, and examples thereof include a hair wig, a hairpiece, a weaving, a hair extension, a braid hair, a hair accessory, and a doll hair. The water-repellent polyacrylonitrile-based synthetic hair fiber may be used alone as synthetic hair to constitute a headdress product. Alternatively, in addition to the water-repellent polyacrylonitrile-based synthetic hair fiber, other synthetic hair fibers and natural fibers such as human hair and animal hair may be combined to constitute a headdress product. The other synthetic hair fibers are not particularly limited, and examples thereof include polyvinyl chloride-based fibers, nylon fibers, polyester fibers, and regenerated collagen fibers.

### EXAMPLES

Hereinafter, one or more embodiments of the present invention will be described in more detail based on Examples and Comparative Examples, and one or more embodiments of the present invention are not limited to the following Examples.

### Examples 1-1 to 12-1 and Comparative Examples 1-1 to 2-1

### (Preparation of Oil Agent)

The following water repellent (B), the following modified silicone (C), the following antistatic agent (D), and water were mixed in contents described in the following Table 1-1 to prepare oil agents 1-1 to 12-1 and comparative oil agents 1-1 to 2-1, which are oil agent aqueous solutions.

The oil agents 1-1 and 2-1, the oil agents 4-1 and 5-1, and the oil agents 9-1 and 10-1 in Table 1-1 have the same compositions, but as will be described later, a method of applying an oil agent to the polyacrylonitrile-based synthetic fiber (A) when preparing a water-repellent polyacrylonitrile-based synthetic hair fiber is different from Preparation Examples A and B, and thus different oil agent numbers are used for convenience.

The following B1-1 to B2-1 were used as the water repellent (B).
B1-1: dendrimer-based water repellent (“RUCO-DRY ECO PSS” manufactured by RUDOLF GmbH)
B2-1: dendrimer-based water repellent (“RUCO-DRY ECO PLUS” manufactured by RUDOLF GmbH)

The following C1 to C2 were used as the modified silicone (C).
C1: epoxy-modified silicone (“POLON-MF-18T” manufactured by Shin-Etsu Chemical Co., Ltd.)
C2: amino-modified silicone (“POLON-MF-63” manufactured by Shin-Etsu Chemical Co., Ltd.)

The following D1 was used as the antistatic agent (D). D1: quaternary ammonium salt

TABLE 1-1

| | Water | Modified | Antistatic | | Method of |
|---|---|---|---|---|---|
| | repellent(B) | silicone(C) | agent(D) | Water | applying |
| | Type/mass % | Type/mass % | Mass % | Mass % | oil agent |
| Oil agent 1-1 | B1-1/1.3 | — | D1/0.65 | 98.05 | A |
| Oil agent 2-1 | B1-1/1.3 | — | D1/0.65 | 98.05 | B |
| Oil agent 3-1 | B1-1/1.3 | C1/0.25 | D1/0.65 | 97.80 | B |
| Oil agent 4-1 | B1-1/1.3 | C1/0.65 | D1/0.65 | 97.40 | A |
| Oil agent 5-1 | B1-1/1.3 | C1/0.65 | DI/0.65 | 37.40 | B |
| Oil agent 6-1 | B1-1/1.3 | C1/2.5 | D1/0.65 | 95.55 | B |
| Oil agent 7-1 | B1-1/0.25 | C1/0.65 | D1/0.65 | 98.45 | B |
| Oil agent 8-1 | B1-1/4.0 | C1/0.65 | D1/0.65 | 94.70 | B |
| Oil agent 9-1 | B2-1/1.3 | — | D1/0.65 | 98.05 | A |
| Oil agent 10-1 | B2-1/1.3 | — | D1/0.65 | 98.05 | B |
| Oil agent 11-1 | B2-1/1.3 | C1/0.65 | D1/0.65 | 97.40 | B |
| Oil agent 12-1 | B1-1/1.3 | C2/0.35 | D1/0.65 | 97.40 | B |
| Comparative | B1-1/0.05 | C1/0.65 | D1/0.65 | 98.65 | B |
| oil agent 1-1 | | | | | |
| Comparative | B1-1/6.0 | C1/0.65 | D1/0.65 | 92.70 | B |
| oil agent 2-1 | | | | | |

### [Preparation Example A] (Examples 1-1, 4-1, and 9-1)

An acrylonitrile-based polymer obtained by copolymerizing 49 mass % of acrylonitrile, 50.5 mass % of vinyl chloride, and 0.5 mass % of sodium styrene sulfonate was dissolved in acetone to prepare a resin solution having a resin concentration of 29.5 mass %. Next, a black pigment (acetone solution, 10.5 mass %) as a coloring agent was added to the resin solution in an amount of 19.2 parts by mass with respect to 100 parts by mass of the acrylonitrile-based polymer to prepare a spinning raw solution. The spinning raw solution was extruded from a spinning nozzle (hole diameter: 0.4 mm, number of holes: 100) into a coagulation bath of 25 mass % of an acetone aqueous solution at 25° C. and wet-spun at a spinning speed of 3 m/min, and then stretched 2.0 times in a stretching bath of 20 mass % of an acetone aqueous solution at 50° C. Subsequently, a yarn was washed with hot water at 80° C. while being stretched 1.1 times, immersed for 1 to 2 seconds in an oil agent tank (60° C.) into which each oil agent described in Table 1-1 was introduced, and impregnated with the oil agent, and then the oil agent was squeezed by a nip roll so that 20 mass % of the oil agent is attached to the polyacrylonitrile-based synthetic fiber (A). Subsequently, the yarn was dried at 130° C., then stretched 2.1 times, and subjected to 8% relaxation shrinkage under heat treatment conditions at 150° C. for 90 seconds to prepare water-repellent polyacrylonitrile-based synthetic hair fibers having a single fiber fineness of about 46 dtex of Examples 1-1, 4-1, and 9-1 described in the following Table 2-1.

The above-described Preparation Example A corresponds to the above-described <<method 1 for producing a water-repellent polyacrylonitrile-based synthetic hair fiber>>. In the present examples, in Table 1-1 or the like, “A” described in the column of “method of applying oil agent” indicates that the water-repellent polyacrylonitrile-based synthetic hair fiber was produced by using a method corresponding to the production method 1.

### [Preparation Example B] (Examples 2-1 to 3-1, 5-1 to 8-1, and 10-1 to 12-1, and Comparative Examples 1-1 to 2-1)

100 g of modacrylic fibers (“AFRELLE” manufactured by Kaneka Corporation, 46 dtex), which is a headdress product, were washed with hot water at 60° C. and then dried at room temperature for one day. Next, the polyacrylonitrile-based synthetic fiber (A) after being dried was immersed for 5 minutes in the oil agent tank (60° C.) into which each oil agent described in Table 1-1 was introduced, a fiber bundle was impregnated with an oil agent composition containing a water repellent, and then an amount of the oil agent attached was adjusted using a small stretching dehydrator so that the amount of the oil agent was 20 mass % with respect to the mass of the fiber bundle. Subsequently, both ends of the fiber bundle were fixed, and heated at 150° C. for 40 minutes, followed by drying and heat treatment to prepare water-repellent polyacrylonitrile-based synthetic hair fibers of Examples 2-1 to 3-1, 5-1 to 8-1, and 10-1 to 12-1, and Comparative Examples 1-1 to 2-1.

The above-described Preparation Example B corresponds to the above-described <<method 2 for producing a water-repellent polyacrylonitrile-based synthetic hair fiber>>. In the present examples, in Table 1-1 or the like, “B” described in the column of “method of applying oil agent” indicates that the water-repellent polyacrylonitrile-based synthetic hair fiber was produced by using a method corresponding to the production method 2.

In Table 2-1, amounts “% owf” of the water repellent (B), the modified silicone (C), and the antistatic agent (D) attached mean the mass % of the water repellent (B), the modified silicone (C), and the antistatic agent (D) with respect to a total mass of the polyacrylonitrile-based synthetic fiber (A). The amounts of the water repellent (B), the modified silicone (C), and the antistatic agent (D) attached were calculated based on extraction amounts of the respective components obtained by extracting the water repellent (B), the modified silicone (C), and the antistatic agent (D) from a water-repellent polyacrylonitrile-based synthetic hair fiber after the water-repellent polyacrylonitrile-based synthetic hair fiber was prepared.

### <Evaluation>

The obtained water-repellent polyacrylonitrile-based synthetic hair fiber was evaluated for a water repellency and texture according to the following method. Results are shown in Table 2-1.

### (Water Repellency)

A fiber bundle with a total fineness of 1,242,000 dtex was prepared and cut into 10 cm, and a portion of 1 cm from one end was fixed with a binding band. Next, distilled water was added to a 500 ml container up to an edge thereof, and the entire fiber bundle was immersed in water with an end of the fiber bundle fixed with the binding band facing up, and an upper portion of the container was closed to prevent the fiber bundle from coming out of a water surface. A time taken for the fiber bundle to settle to a bottom of the container was measured. When the water repellency is high, water slowly permeates into a center of the fiber bundle, and thus it takes a long time for the fiber bundle to settle to the bottom of the container. The water repellency was evaluated as follows based on the time until the fiber bundle is settled.
30 minutes or longer: high water repellency is observed (o)
3 minutes or longer and less than 30 minutes: water repellency is observed (Δ)
less than 3 minutes: no sufficient water repellency is observed (x)

### (Texture)

Three or more people who have been engaged in a hairpiece beauty evaluation for three years or longer perform a sensory evaluation using a fiber bundle sample having a total fineness of 1,200,000 dtex to 1,300,000 dtex, and comprehensively determine texture such as softness, sliminess, and moistness based on the following three criteria as compared with AFRELLE (modacrylic fiber manufactured by Kaneka Corporation, 46 dtex).
A (very good): having a better texture than AFRELLE.
B (good): having texture equivalent to that of AFRELLE.
C (poor): having a poorer texture than AFRELLE.

TABLE 2-1

| | | Water | Modified | Antistatic | | | |
|---|---|---|---|---|---|---|---|
| | | repellent(B) | silicone(C) | agent(D) | Water repellency | | |
| | | Type/ [symbol] | Type/ [symbol] / [symbol] | Type/ [symbol] / [symbol] | Settling time | Evaluation | Texture |
| Example 1-1 | Oil agent 1-1 | B1-1/0.26 | — | D1/0.13 | 30 minutes or longer | ◯ | B |
| Example 2-1 | Oil agent 3-1 | B1-1/0.26 | — | D1/0.13 | 30 minutes or longer | ◯ | B |
| Example 3-1 | Oil agent 3-1 | B1-1/0.26 | C1/0.05 | D1/0.13 | 30 minutes or longer | ◯ | A |
| Example 4-1 | Oil agent 4-1 | B1-1/0.26 | C1/0.13 | D1/0.13 | [symbol] minutes | Δ | A |
| Example 5-1 | Oil agent 3-1 | B1-1/0.26 | C1/0.13 | D1/0.13 | [symbol] minutes | Δ | A |
| Example 6-1 | Oil agent 6-1 | B1-1/0.26 | C1/0.5 | D1/0.13 | 7 minutes | Δ | B |
| Example 7-1 | Oil agent 7-1 | B1-1/0.05 | C1/0.13 | D1/0.13 | [symbol] minutes | Δ | A |
| Example 8-1 | Oil agent 8-1 | B1-1/0.8 | C1/0.13 | D1/0.13 | [symbol] minutes | Δ | B |
| Example 9-1 | Oil agent 9-1 | B1-1/0.25 | — | D1/0.13 | 25 minutes | Δ | B |
| Example 10-1 | Oil agent 10-1 | B1-1/0.26 | — | D1/0.13 | 30 minutes or longer | ◯ | B |
| Example 11-1 | Oil agent 11-1 | B1-1/0.26 | C1/0.07 | D1/0.13 | 10 minutes | Δ | A |
| Example 12-1 | Oil agent 12-1 | B1-1/0.26 | C2/0.13 | D1/0.13 | 30 minutes or longer | ◯ | A |
| Comparative | Comparative | B1-1/0.01 | C1/0.13 | D1/0.13 | Less than [symbol] minutes | [symbol] | A |
| Example1-1 | oil agent 1-1 | | | | | | |
| Comparative | Comparative | B1-1/1.2 | C1/0.13 | D1/0.13 | [symbol] minutes | Δ | ◯ |
| Example2-1 | oil agent 2-1 | | | | | | |

[symbol]

indicates data missing or illegible when filed

Based on Table 2-1, it can be seen that the water-repellent polyacrylonitrile-based synthetic hair fibers of Examples 1-1 to 12-1 have a high water repellency while having texture of synthetic hair, and on the other hand, as described in Comparative Examples 1-1 to 2-1, when the amount of the water repellent (B) attached is extremely small or exceeds 1.0 mass %, both the texture and the water repellency of the synthetic hair cannot be achieved.

### Examples 1A-1 to 18A-1 and Comparative Examples 1A-1 to 4A-1

### (Preparation of Oil Agent)

The water repellent (B), the modified silicone (C), the antistatic agent (D), and water, which are used in Examples 1-1 to 12-1 and Comparative Examples 1-1 to 2-1, were mixed in contents described in the following Table 3-1 to prepare oil agents 1A-1 to 18A-1 and comparative oil agents 1A-1 to 4A-1, which are oil agent aqueous solutions.

In the oil agents 17A-1 and 18A-1, the following D2 and D3 were used as the antistatic agent (D).
D2: guanidine-based cationic antistatic agent (“Nice pole FL” manufactured by NICCA CHEMICAL CO., LTD.)
D3: polyoxyethylene alkyl ether type nonionic antistatic agent (“Nonion K-230” manufactured by NOF CORPORATION)

### [Preparation Example B] (Examples 1A-1 to 18A-1 and Comparative Examples 1A-1 to 4A-1)

In the above-described “[Preparation Example B] (Examples 2-1 to 3-1, 5-1 to 8-1, and 10-1 to 12-1, and Comparative Examples 1-1 to 2-1)”, water-repellent polyacrylonitrile-based synthetic hair fibers of Examples 1A-1 to 18A-1 and Comparative Examples 1A-1 to 4A-1 described in the following Table 4-1 were prepared in the same manner as in the above-described Preparation Example B except that each oil agent described in the following Table 3-1 was used instead of each oil agent described in Table 1-1.

### <Evaluation>

The obtained water-repellent polyacrylonitrile-based synthetic hair fiber was evaluated for a water repellency and texture according to the above-described method. In addition, in Examples 14A-1 to 18A-1, a static electricity amount was evaluated according to the following method. Results are shown in Table 4-1.

### (Static Electricity Amount)

A fiber bundle with a total fineness of 1,242,000 dtex was prepared and cut into 30 cm, and a portion of 5 cm from one end was fixed with a binding band and left to stand for 1 hour in a constant temperature and humidity chamber at a temperature of 23° C. and a humidity of 50% RH. Next, an upper portion of the fiber bundle was held in the constant temperature and humidity chamber, a plastic comb was passed three times in the fiber bundle, and immediately, a static electricity measuring apparatus (STATIRON DZ4 manufactured by SHISHIDO ELECTROSTATIC, LTD.) was brought close to the fiber bundle to a distance of 5 cm and measures a static electricity amount. The static electricity amount was evaluated as follows based on values of static electricity.
−6 kV or more and +6 kV or less: static electricity is reduced (o)
less than −6 kV or more than +6 kV: strong static electricity is generated (x)

TABLE 3-1

| | Water | Modified | Antistatic | | Method of |
|---|---|---|---|---|---|
| | repellent(B) | silicone(C) | agent(D) | Water | applying |
| | Type/mass % | Type/mass % | Mass % | Mass % | oil agent |
| Comparative oil | B1-1/0.05 | C1/0.65 | — | 99.3 | B |
| agent 1A-1 | | | | | |
| Oil agent 1A-1 | B1-1/0.25 | C1/0.65 | — | 99.10 | B |
| Oil agent 2A-1 | B1-1/1.3 | | — | 98.70 | B |
| Oil agent 3A-1 | B1-1/1.3 | C1/0.25 | — | 98.45 | B |
| Oil agent 4A-1 | B1-1/1.3 | C1/0.65 | — | 98.05 | B |
| Oil agent SA-1 | B1-1/1.3 | C1/2.5 | — | 96.20 | |
| Oil agent 6A-1 | B1-1/4.0 | C1/0.65 | — | 95.35 | B |
| Comparative oil | B1-1/6.0 | C1/0.65 | — | 93.35 | B |
| agent 2A-1 | | | | | |
| Comparative oil | B1-1/0.05 | C1/0.65 | D1/0.65 | 98.65 | B |
| agent 3A-1 | | | | | |
| Oil agent 7A-1 | B1-1/1.3 | — | D1/0.65 | 98.05 | B |
| Oil agent 8A-1 | B1-1/1.3 | C1/0.0165 | D1/0.65 | 98.03 | |
| Oil agent SA-1 | B1-1/1.3 | C1/0.0325 | D1/0.65 | 98.02 | |
| Oil agent 10A-1 | B1-1/1.3 | C1/0.065 | D1/0.65 | 97.39 | B |
| Oil agent 11A-1 | B1-1/1.3 | C1/0.25 | D1/0.65 | 97.80 | B |
| Oil agent 12A-1 | B1-1/1.3 | C1/0.65 | D1/0.65 | 97.40 | B |
| Oil agent 13A-1 | B1-1/1.3 | C1/2.5 | D1/0.65 | 95.55 | B |
| Comparative oil | B1-1/6.0 | C1/0.65 | D1/0.65 | 92.70 | B |
| agent 4A-1 | | | | | |
| Oil agent 14A-1 | B1-1/1.3 | C1/0.065 | D1/0.15 | 98.49 | B |
| Oil agent 15A-1 | B1-1/1.3 | C1/0.065 | D1/0.45 | 98.19 | B |
| Oil agent 164-1 | B1-1/1.3 | C1/0.065 | D1/0.85 | 97.79 | B |
| Oil agent 17A-1 | B1-1/1.3 | C1/0.04 | D2/0.2 | 98.46 | B |
| Oil agent 18A-1 | B1-1/1.3 | C1/0.04 | D3/0.2 | 98.46 | B |

TABLE 4-1

| | | | | | | | | | | | |
|---|---|---|---|---|---|---|---|---|---|---|---|
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |

[symbol]

indicates data missing or illegible when filed

Based on Table 4-1, it can be seen that when a mass ratio of the amount of the dendrimer-based water repellent (B-1) attached to the amount of the modified silicone (C) attached is (B-1):(C)=1:0.03 or more and 1:0.3 or less, both the water repellency and the texture are superior.

In addition, it can be seen that when a mass ratio of the amount of the dendrimer-based water repellent (B-1) attached to the amount of the antistatic agent (D) attached is (B-1):(D)=1:0.15 or more and 1:0.7 or less, both the water repellency and an effect of reducing static electricity are superior.

### Examples 1-2 to 9-2 and Comparative Examples 1-2 to 2-2

### (Preparation of Oil Agent)

The following water repellent (B), the following modified silicone (C), the following antistatic agent (D), and water were mixed in contents described in the following Table 1-2 to prepare oil agents 1-2 to 9-2 and comparative oil agents 1-2 to 2-2, which are oil agent aqueous solutions.

The oil agents 1-2 and 2-2, and the oil agents 4-2 and 5-2 in Table 1-2 have the same compositions, but as will be described later, a method of applying an oil agent to the polyacrylonitrile-based synthetic fiber (A) when preparing a water-repellent polyacrylonitrile-based synthetic hair fiber is different from Preparation Examples A and B, and thus different oil agent numbers are used for convenience.

The following B1-2 was used as the water repellent (B). B1-2: alkyl urethane-based water repellent (“ZELAN R3” manufactured by HUNTSMAN)

The following C1 to C2 were used as the modified silicone (C).
C1: epoxy-modified silicone (“POLON-MF-18T” manufactured by Shin-Etsu Chemical Co., Ltd.)
C2: amino-modified silicone (“POLON-MF-63” manufactured by Shin-Etsu Chemical Co., Ltd.)

The following D1 was used as the antistatic agent (D). D1: cationic antistatic agent

TABLE 1-2

| | Water | Modified | Antistatic | | Method of |
|---|---|---|---|---|---|
| | repellent(B) | silicone(C) | agent(D) | Water | applying |
| | Type/mass % | Type/mass % | Mass % | Mass % | oil agent |
| Oil agent 1-2 | B1-2/1.3 | — | D1/0.65 | 98.05 | A |
| Oil agent 2-2 | B1-2/1.3 | — | D1/0.65 | 98.05 | B |
| Oil agent 3-2 | B1-2/1.3 | C1/0.25 | D1/0.65 | 97.80 | B |
| Oil agent 4-2 | B1-2/1.3 | C1/0.65 | D1/0.65 | 97.40 | A |
| Oil agent 5-2 | B1-2/1.3 | C1/0.65 | D1/0.65 | 97.40 | B |
| Oil agent 6-2 | B1-2/1.3 | C1/2.5 | D1/0.65 | 95.55 | B |
| Oil agent 7-2 | B1-2/0.25 | C1/0.65 | D1/0.65 | 98.45 | B |
| Oil agent 8-2 | B1-2/4.0 | C1/0.65 | D1/0.65 | 94.70 | B |
| Oil agent 9-2 | B1-2/1.3 | C2/0.65 | D1/0.65 | 97.40 | B |
| Comparative | — | C1/0.65 | D1/0.65 | 98.70 | B |
| oil agent 1-2 | | | | | |
| Comparative | B1-2/6.0 | C1/0.65 | D1/0.65 | 92.70 | B |
| oil agent 2-2 | | | | | |

### [Preparation Example A] (Examples 1-2 and 4-2)

In the above-described “[Preparation Example A] (Examples 1-1, 4-1, and 9-1)”, water-repellent polyacrylonitrile-based synthetic hair fibers of Examples 1-2 and 4-2 described in the following Table 2-2 were prepared in the same manner as in the above-described Preparation Example A except that each oil agent described in Table 1-2 was used instead of each oil agent described in Table 1-1.

### [Preparation Example B] (Examples 2-2 to 3-2 and 5-2 to 9-2, and Comparative Examples 1-2 to 2-2)

In the above-described “[Preparation Example B] (Examples 2-1 to 3-1, 5-1 to 8-1, and 10-1 to 12-1, and Comparative Examples 1-1 to 2-1)”, water-repellent polyacrylonitrile-based synthetic hair fibers of Examples 2-2 to 3-2 and 5-2 to 9-2, and Comparative Examples 1-2 to 2-2 described in the following Table 2-2 were prepared in the same manner as in the above-described Preparation Example B except that each oil agent described in Table 1-2 was used instead of each oil agent described in Table 1-1.

In Table 2-2, amounts “% owf” of the water repellent (B), the modified silicone (C), and the antistatic agent (D) attached mean the mass % of the water repellent (B), the modified silicone (C), and the antistatic agent (D) with respect to a total mass of the polyacrylonitrile-based synthetic fiber (A). The amounts of the water repellent (B), the modified silicone (C), and the antistatic agent (D) attached were calculated based on extraction amounts of the respective components obtained by extracting the water repellent (B), the modified silicone (C), and the antistatic agent (D) from a water-repellent polyacrylonitrile-based synthetic hair fiber after the water-repellent polyacrylonitrile-based synthetic hair fiber was prepared.

### <Evaluation>

The obtained water-repellent polyacrylonitrile-based synthetic hair fiber was evaluated for a water repellency and texture in the same manner as described above. Results are shown in Table 2-2.

TABLE 2-2

| | | Water | Modified | | | | |
|---|---|---|---|---|---|---|---|
| | | repellent( [symbol] ) | silicone(C) | Antistatic | Water repellency | | |
| | | Type/ [symbol] | Type/ [symbol] | Type/ [symbol] | Settling time | Evaluation | Texture |
| Example 1-2 | Oil agent 1-2 | B1-2/0.26 | — | D1/0.13 | 30 minutes or longer | ◯ | B |
| Example 2-2 | Oil agent 2-2 | B1-2/0.26 | — | D1/0.13 | 30 minutes or longer | ◯ | B |
| Example 3-2 | Oil agent 3-2 | B1-2/0.26 | C1/0.05 | D1/0.33 | 30 minutes or longer | ◯ | A |
| Example 4-2 | Oil agent 4-2 | B1-2/0.26 | C1/0.13 | D1/0.13 | 30 minutes of longer | ◯ | A |
| Example 5-2 | Oil agent 5-2 | B1-2/0.26 | C1/0.13 | D1/0.13 | 30 minutes or longer | ◯ | A |
| Example 6-2 | Oil agent 6-2 | B1-2/0.26 | C1/0.5 | D1/0.13 | 15 minutes | Δ | B |
| Example 7-2 | Oil agent 7-2 | B1-2/0.05 | C1/0.13 | D1/0.13 | 30 minutes or longer | ◯ | A |
| Example 8-2 | Oil agent 8-2 | B1-2/0.8 | C1/0.13 | D1/0.33 | 30 minutes of longer | ◯ | B |
| Example 9-2 | Oil agent 8-2 | B1-2/0.26 | C2/0.13 | D1/0.13 | 30 minutes or longer | ◯ | B |
| Comparative | Comparative | — | C1/0.13 | D1/0.13 | Less than 3 minutes | X | A |
| Example1-2 | oil agent 1-2 | | | | | | |
| Comparative | Comparative | B1-2/1.2 | C1/0.13 | D1/0.13 | 30 minutes or longer | ◯ | C |
| Example2-2 | oil agent 2-2 | | | | | | |

[symbol]

indicates data missing or illegible when filed

Based on Table 2-2, it can be seen that the water-repellent polyacrylonitrile-based synthetic hair fibers of Examples 1-2 to 9-2 have a high water repellency while having texture of synthetic hair, and on the other hand, as described in Comparative Examples 1-2 to 2-2, when the amount of the water repellent (B) attached is extremely small or exceeds 1.0 mass %, both the texture and the water repellency of the synthetic hair cannot be achieved.

### [Examples 1A-2 to 18A-2 and Comparative Examples 1A-2 to 2A-2]

### (Preparation of Oil Agent)

The water repellent (B), the modified silicone (C), the antistatic agent (D), and water, which are used in Examples 1-2 to 9-2 and Comparative Examples 1-2 to 2-2, were mixed in contents described in the following Table 3-2 to prepare oil agents 1A-2 to 18A-2 and comparative oil agents 1A-2 to 2A-2, which are oil agent aqueous solutions.

In the oil agents 17A-2 and 18A-2, the following D2 and D3 were used as the antistatic agent (D).
D2: guanidine-based cationic antistatic agent (“Nice pole FL” manufactured by NICCA CHEMICAL CO., LTD.)
D3: polyoxyethylene alkyl ether type nonionic antistatic agent (“Nonion K-230” manufactured by NOF CORPORATION)

### [Preparation Example B] (Examples 1A-2 to 18A-2 and Comparative Examples 1A-2 to 2A-2)

In the above-described “[Preparation Example B] (Examples 2-1 to 3-1, 5-1 to 8-1, and 10-1 to 12-1, and Comparative Examples 1-1 to 2-1)”, water-repellent polyacrylonitrile-based synthetic hair fibers of Examples 1A-2 to 18A-2 and Comparative Examples 1A-2 to 2A-2 described in the following Table 4-2 were prepared in the same manner as in the above-described Preparation Example B except that each oil agent described in the following Table 3-2 was used instead of each oil agent described in Table 1-1.

### <Evaluation>

The obtained water-repellent polyacrylonitrile-based synthetic hair fiber was evaluated for a water repellency and texture according to the above-described method. In addition, in Examples 14A-2 to 18A-2, a static electricity amount was evaluated according to the above-described method. Results are shown in Table 4-2.

TABLE 3-2

| | Water | Modified | Antistatic | | Method of |
|---|---|---|---|---|---|
| | repellent(B) | silicone(C) | agent(D) | Water | applying |
| | Type/mass % | Type/mass % | Mass % | Masse | oil agent |
| Comparative oil | B1-2/0.05 | C1/0.65 | — | 99.30 | B |
| agent 1A-2 | | | | | |
| Oil agent 1A-2 | B1-2/0.25 | C1/0.65 | — | 99.10 | B |
| Oil agent 2A-2 | B1-2/1.3 | — | — | 98.70 | B |
| Oil agent 3A-2 | B1-2/1.3 | C1/0.25 | — | 98.45 | B |
| Oil agent 4A-2 | B1-2/1.3 | C1/0.65 | — | 98.05 | B |
| Oil agent 5A-2 | B1-2/1.3 | C1/2.5 | — | 96.20 | B |
| Oil agent 6A-2 | B1-2/4.0 | C1/0.65 | — | 95.35 | B |
| Comparative oil | B1-2/6.0 | C1/0.65 | — | 93.35 | B |
| agent 2A-2 | | | | | |
| Oil agent 7A-2 | B1-2/1.3 | — | D1/0.65 | 98.05 | B |
| Oil agent 8A-2 | B1-2/1.3 | C1/0.0165 | D1/0.65 | 98.03 | B |
| Oil agent 9A-2 | B1-2/1.3 | C1/0.0325 | D1/0.65 | 98.02 | B |
| Oil agent 10A-2 | B1-2/1.3 | C1/0.065 | D1/0.65 | 97.99 | B |
| Oil agent 11A-2 | B1-2/1.3 | C1/0.25 | D1/0.65 | 97.80 | B |
| Oil agent 12A-2 | B1-2/1.3 | C1/0.65 | D1/0.65 | 97.40 | B |
| Oil agent 13A-2 | B1-2/1.3 | C1/2.5 | D1/0.65 | 95.55 | B |
| Oil agent 14A-2 | B1-2/1.3 | C1/0.065 | D1/0.15 | 98.49 | B |
| Oil agent 15A-2 | B1-2/1.3 | C1/0.065 | D1/0.45 | 98.19 | B |
| Oil agent 16A-2 | B1-2/1.3 | C1/0.065 | D1/0.85 | 97.79 | B |
| Oil agent 17A-2 | B1-2/1.3 | C1/0.04 | D2/0.2 | 98.46 | B |
| Oil agent 18A-2 | B1-2/1.3 | C1/0.04 | D3/0.2 | 98.46 | B |

TABLE 4-2

| | | Water | | | | | | | | | |
|---|---|---|---|---|---|---|---|---|---|---|---|
| | | [symbol] | [symbol] | [symbol] | [symbol] | | | [symbol] | | | |
| | | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |

[symbol]

indicates data missing or illegible when filed

Based on Table 4-2, it can be seen that when a mass ratio of the amount of the alkyl urethane-based water repellent (B-2) attached to the amount of the modified silicone (C) attached is (B-2):(C)=1:0.03 or more and 1:0.5 or less, both the water repellency and the texture are superior.

In addition, it can be seen that when a mass ratio of the amount of the alkyl urethane-based water repellent (B-2) attached to the amount of the antistatic agent (D) attached is (B-2):(D)=1:0.15 or more and 1:0.7 or less, both the water repellency and an effect of reducing static electricity are superior.

### Examples 1-3 to 5-3 and Comparative Examples 1-3 to 4-3

### (Preparation of Oil Agent)

The following silicone (B), the following antistatic agent (D), and water were mixed in contents described in the following Table 1-3 to prepare oil agents 1-3 to 5-3 and comparative oil agents 1-3 to 4-3, which are oil agent aqueous solutions.

The oil agents 3-3 and 4-3 in Table 1-3 have the same compositions, but as will be described later, methods of applying the oil agents to the polyacrylonitrile-based synthetic fiber (A) when preparing a water-repellent polyacrylonitrile-based synthetic hair fiber are different from Preparation Examples A and B, and thus different oil agent numbers are used for convenience.

The following B1-3 to B3-3 were used as the silicone (B). B1-3: condensation reaction type polydimethylsiloxane-based water repellent (“Rikenpalan SG-54” manufactured by MIKIRIKEN INDUSTRIAL CO., LTD.)
B2-3: epoxy-modified silicone (“POLON-MF-18T” manufactured by Shin-Etsu Chemical Co., Ltd.)
B3-3: silicone-based compound (“NeoSeed NR-8000” manufactured by NICCA CHEMICAL CO., LTD.)

The following D1 was used as the antistatic agent (D). D1: cationic antistatic agent

TABLE 1-3

| | | Antistatic | | Method of |
|---|---|---|---|---|
| | Silicone(B) | agent(D) | Water | applying |
| | Type/mass % | Mass % | Mass % | oil agent |
| Oil agent 1-3 | B1-3/0.25 | D1/0.25 | 99.50 | B |
| Oil agent 2-3 | B1-3/0.5 | D1/0.5 | 99.00 | B |
| Oil agent 3-3 | B1-3/1.3 | D1/0.5 | 98.20 | A |
| Oil agent 4-3 | B1-3/1.3 | D1/0.5 | 98.20 | B |
| Oil agent 5-3 | B1-3/2.0 | D1/0.5 | 97.50 | B |
| Comparative | B1-3/0.05 | D1/0.65 | 99.30 | B |
| oil agent 1-3 | | | | |
| Comparative | B1-3/6.0 | D1/0.65 | 93.35 | B |
| oil agent 2-3 | | | | |
| Comparative | B2-3/1.3 | D1/0.65 | 98.05 | B |
| oil agent 3-3 | | | | |
| Comparative | B3-3/1.3 | D1/0.65 | 98.05 | B |
| oil agent 4-3 | | | | |

### [Preparation Example A] (Example 3-3)

In the above-described “[Preparation Example A] (Examples 1-1, 4-1, and 9-1)”, a water-repellent polyacrylonitrile-based synthetic hair fiber of Example 3-3 described in the following Table 2-3 was prepared in the same manner as in the above-described Preparation Example A except that each oil agent described in Table 1-3 was used instead of each oil agent described in Table 1-1.

### [Preparation Example B] (Examples 1-3 to 2-3 and 4-3 to 5-3, and Comparative Examples 1-3 to 4-3)

In the above-described “[Preparation Example B] (Examples 2-1 to 3-1, 5-1 to 8-1, and 10-1 to 12-1, and Comparative Examples 1-1 to 2-1)”, water-repellent polyacrylonitrile-based synthetic hair fibers of Examples 1-3 to 2-3 and 4-3 to 5-3, and Comparative Examples 1-3 to 4-3 described in the following Table 2-3 were prepared in the same manner as in the above-described Preparation Example B except that each oil agent described in Table 1-3 was used instead of each oil agent described in Table 1-1.

In Table 2-3, amounts “% owf” of the silicone (B) and the antistatic agent (D) attached mean mass % of the silicone (B) and the antistatic agent (D) with respect to a total mass of the polyacrylonitrile-based synthetic fiber (A). The amounts of the silicone (B) and the antistatic agent (C) attached were calculated based on extraction amounts of the respective components obtained by extracting the silicone (B) and the antistatic agent (D) from a water-repellent polyacrylonitrile-based synthetic hair fiber after the water-repellent polyacrylonitrile-based synthetic hair fiber was prepared.

### <Evaluation>

The obtained water-repellent polyacrylonitrile-based synthetic hair fiber was evaluated for a water repellency and texture in the same manner as described above. Results are shown in Table 2-3.

TABLE 2-3

| | | | Antistatic | | | |
|---|---|---|---|---|---|---|
| | | Silicone( [symbol] ) | agent (D) | Water repellency | | |
| | | Type/ [symbol] | Type/ [symbol] | Settling time | Evaluation | Texture |
| Example 1-3 | Oil agent 1-3 | B1-3/0.05 | D1/0,05 | 4 minutes | Δ | B |
| Example 2-3 | Oil agent 2-3 | B1-3/0.10 | D1/0.10 | 27 minutes | Δ | B |
| Example 3-3 | Oil agent 3-3 | B1-3/0.26 | D1/0.10 | 30 minutes or longer | ◯ | A |
| Example 4-3 | Oil agent 4-3 | B1-3/0.26 | D1/0.10 | 30 minutes or longer | ◯ | A |
| Example 5-3 | Oil agent 6-3 | B1-3/0.40 | D1/0.10 | 30 minutes or longer | ◯ | A |
| Comparative | Comparative | B1-3/0.01 | D1/0.13 | Less than 3 minutes | X | B |
| Example1-3 | oil agent 1-3 | | | | | |
| Comparative | Comparative | B1-3/1.2 | D1/0.13 | Less than 3 minutes | X | C |
| Example2-3 | oil agent 2-3 | | | | | |
| Comparative | Comparative | B2-3/0.26 | D1/0.13 | Less then 3 minutes | X | A |
| Example3-3 | oil agent 3-3 | | | | | |
| Comparative | Comparative | B3-3/0.26 | D1/0.13 | 6 minutes | Δ | C |
| Example4-3 | oil agent 4-3 | | | | | |

[symbol]

indicates data missing or illegible when filed

Based on Table 2-3, the water-repellent polyacrylonitrile-based synthetic hair fibers of Comparative Examples 3-3 to 4-3 to which B2-3 or B3-3 was attached as the silicone (B) cannot achieve both the water repellency and the texture of the synthetic hair. On the other hand, based on comparison results of Examples 1-3 to 4-3 and Comparative Examples 1-3 to 2-3, it can be seen that when 0.05 mass % to 1.0 mass % of B1-3 is attached as the silicone (B), the water repellency is improved while the texture of the synthetic hair is also provided.

### Examples 1A-3 to 6A-3

### (Preparation of Oil Agent)

The silicone (B), the antistatic agent (D), and water, which were used in Examples 1-3 to 5-3 and Comparative Examples 1-3 to 4-3, were mixed in contents described in the following Table 3-3 to prepare oil agents 1A-3 to 6A-3, which are oil agent aqueous solutions.

In the oil agents 5A-3 and 6A-3, the following D2 and D3 were used as the antistatic agent (D).
D2: guanidine-based cationic antistatic agent (“Nice pole FL” manufactured by NICCA CHEMICAL CO., LTD.)
D3: polyoxyethylene alkyl ether type nonionic antistatic agent (“Nonion K-230” manufactured by NOF CORPORATION)

### [Preparation Example B] (Examples 1A-3 to 6A-3)

In the above-described “[Preparation Example B] (Examples 2-1 to 3-1, 5-1 to 8-1, and 10-1 to 12-1, and Comparative Examples 1-1 to 2-1)”, water-repellent polyacrylonitrile-based synthetic hair fibers of Examples 1A-3 to 6A-3 described in the following Table 4-3 were prepared in the same manner as in the above-described Preparation Example B except that each oil agent described in the following Table 3-3 was used instead of each oil agent described in Table 1-1.

### <Evaluation>

The obtained water-repellent polyacrylonitrile-based synthetic hair fiber was evaluated for a water repellency and texture according to the above-described method. In addition, in Examples 1A-3 to 6A-3, a static electricity amount was evaluated according to the above-described method. Results are shown in Table 4-3.

TABLE 3-3

| | | Antistatic | | Method of |
|---|---|---|---|---|
| | Silicone(B) | agent(D) | Water | applying |
| | Type/mass % | Type/mass % | Mass % | oil agent |
| Oil agent 1A-3 | B1-3/1.3 | — | 98.70 | B |
| Oil agent 2A-3 | B1-3/1.3 | D1/0.25 | 98.45 | B |
| Oil agent 3A-3 | B1-3/1.3 | D1/0.5 | 98.20 | B |
| Oil agent 4A-3 | B1-3/1.3 | D1/1.3 | 97.40 | B |
| Oil agent 5A-3 | B1-3/1.3 | D2/0.2 | 98.50 | B |
| Oil agent 6A-3 | B1-3/1.3 | D3/0.2 | 98.50 | B |

TABLE 4-3

| | | | [symbol] | | | | | Static |
|---|---|---|---|---|---|---|---|---|
| | | Silicone(B) | agent(D) | | | Water repellency | | electricity |
| | | Type/Example [symbol] | Type/ [symbol] | Ratio | | Settling time | Evaluation | [symbol] |
| Example [symbol] | Oil agent [symbol] | — | — | [symbol] | [symbol] | [symbol] | A | [symbol] |
| Example [symbol] | Oil agent [symbol] | — | [symbol] | [symbol] | [symbol] | [symbol] | A | [symbol] |
| Example [symbol] | Oil agent [symbol] | — | [symbol] | [symbol] | [symbol] | [symbol] | A | [symbol] |
| Example [symbol] | Oil agent [symbol] | — | [symbol] | [symbol] | [symbol] | [symbol] | A | [symbol] |
| Example [symbol] | Oil agent [symbol] | — | [symbol] | [symbol] | [symbol] | [symbol] | A | [symbol] |
| Example [symbol] | Oil agent [symbol] | — | [symbol] | [symbol] | [symbol] | [symbol] | A | [symbol] |

[symbol]

indicates data missing or illegible when filed

Based on Table 4-3, it can be seen that when a mass ratio of the amount of the condensation reaction type polydimethylsiloxane (B-3) attached to the amount of the antistatic agent (D) attached is (B-3):(D)=1:0.15 or more and 1:0.7 or less, both the water repellency and an effect of reducing static electricity are superior.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A water-repellent polyacrylonitrile-based synthetic hair fiber comprising:
a polyacrylonitrile-based synthetic fiber (A); and
a water repellent (B) attached to the polyacrylonitrile-based synthetic fiber (A), wherein
the water repellent (B) does not have a fluoro group,
the water repellent (B) contains at least one selected from the group consisting of a dendrimer-based water repellent (B-1), an alkyl urethane-based water repellent (B-2), and condensation reaction type polydimethylsiloxane (B-3),
the dendrimer-based water repellent (B-1) has an ester and/or urethane bond,
the alkyl urethane-based water repellent (B-2) has a long-chain hydrocarbon side chain and is non-dendrimer-based,
the condensation reaction type polydimethylsiloxane (B-3) has, at both terminals, a hydroxy group, an organic group having a hydroxy group, or an organic group capable of generating a hydroxy group, and
an amount of the water repellent (B) attached to the polyacrylonitrile-based synthetic fiber (A) is 0.05 mass % or more and 1.0 mass % or less with respect to a total mass of the polyacrylonitrile-based synthetic fiber (A).

2. The water-repellent polyacrylonitrile-based synthetic hair fiber according to claim 1, further comprising: a modified silicone (C) attached to the polyacrylonitrile-based synthetic fiber (A), wherein
the modified silicone (C) is a dimethylsiloxane polymer substituted with an epoxy group and/or an amino group, and
an amount of the modified silicone (C) attached to the polyacrylonitrile-based synthetic fiber (A) is 0.01 mass % or more and 0.5 mass % or less with respect to the total mass of the polyacrylonitrile-based synthetic fiber (A).

3. The water-repellent polyacrylonitrile-based synthetic hair fiber according to claim 1, wherein the dendrimer-based water repellent (B-1) has a hydrophobic terminal residue.

4. The water-repellent polyacrylonitrile-based synthetic hair fiber according to claim 1, wherein the alkyl urethane-based water repellent (B-2) has a skeleton derived from sorbitan.

5. The water-repellent polyacrylonitrile-based synthetic hair fiber according to claim 1, further comprising: an ionic antistatic agent (D1) and/or a nonionic antistatic agent (D2) as an antistatic agent (D) attached to the polyacrylonitrile-based synthetic fiber (A), wherein
an amount of the antistatic agent (D) attached to the polyacrylonitrile-based synthetic fiber (A) is 0.05 mass % or more and 0.3 mass % or less with respect to the total mass of the polyacrylonitrile-based synthetic fiber (A).

6. The water-repellent polyacrylonitrile-based synthetic hair fiber according to claim 1, wherein a mass ratio of an amount of the dendrimer-based water repellent (B-1) attached to the polyacrylonitrile-based synthetic fiber (A) to an amount of a modified silicone (C) attached to the polyacrylonitrile-based synthetic fiber (A) is (B-1): (C)=1:0.03 or more and 1:0.3 or less.

7. The water-repellent polyacrylonitrile-based synthetic hair fiber according to claim 1, wherein a mass ratio of an amount of the alkyl urethane-based water repellent (B-2) attached to the polyacrylonitrile-based synthetic fiber (A) to an amount of a modified silicone (C) attached to the polyacrylonitrile-based synthetic fiber (A) is (B-2):(C)=1:0.03 or more and 1:0.5 or less.

8. The water-repellent polyacrylonitrile-based synthetic hair fiber according to claim 5, wherein a mass ratio of the amount of the water repellent (B) attached to the polyacrylonitrile-based synthetic fiber (A) to the amount of the antistatic agent (D) attached to the polyacrylonitrile-based synthetic fiber (A) is (B):(D)=1:0.15 or more and 1:0.7 or less.

9. The water-repellent polyacrylonitrile-based synthetic hair fiber according to claim 5, wherein
a mass ratio of an amount of the dendrimer-based water repellent (B-1) attached to the polyacrylonitrile-based synthetic fiber (A) to an amount of a modified silicone (C) attached to the polyacrylonitrile-based synthetic fiber (A) is (B-1):(C)=1:0.03 or more and 1:0.3 or less, and
a mass ratio of the amount of the dendrimer-based water repellent (B-1) attached to the polyacrylonitrile-based synthetic fiber (A) to the amount of the antistatic agent (D) attached to the polyacrylonitrile-based synthetic fiber (A) is (B-1):(D)=1:0.15 or more and 1:0.7 or less.

10. The water-repellent polyacrylonitrile-based synthetic hair fiber according to claim 5, wherein
a mass ratio of an amount of the alkyl urethane-based water repellent (B-2) attached to the polyacrylonitrile-based synthetic fiber (A) to an amount of a modified silicone (C) attached to the polyacrylonitrile-based synthetic fiber (A) is (B-2):(C)=1:0.03 or more and 1:0.5 or less, and
a mass ratio of the amount of the alkyl urethane-based water repellent (B-2) attached to the polyacrylonitrile-based synthetic fiber (A) to the amount of the antistatic agent (D) attached to the polyacrylonitrile-based synthetic fiber (A) is (B-2):(D)=1:0.15 or more and 1:0.7 or less.

11. The water-repellent polyacrylonitrile-based synthetic hair fiber according to claim 1, wherein a single fiber fineness is 1 dtex or more and 100 dtex or less.

12. A method for producing the water-repellent polyacrylonitrile-based synthetic hair fiber according to claim 1, the method comprising:
obtaining a coagulated yarn by wet-spinning a spinning solution containing an acrylonitrile-based polymer; and
bringing a yarn comprising the coagulated yarn into contact with an oil agent containing the water repellent (B), before drying the yarn.

13. A method for producing the water-repellent polyacrylonitrile-based synthetic hair fiber according to claim 1, the method comprising:
performing a contact treatment to a dried polyacrylonitrile-based synthetic fiber (A) to obtain a contact-treated polyacrylonitrile-based synthetic fiber (A), wherein in the contact treatment, the dried polyacrylonitrile-based synthetic fiber (A) is brought into contact with an oil agent containing the water repellent (B); and
after the performing of the contact treatment, drying a thread of the contact-treated polyacrylonitrile-based synthetic fiber (A).

14. A headdress product comprising the water-repellent polyacrylonitrile-based synthetic hair fiber according to claim 1.

15. The headdress product according to claim 14, wherein the headdress product is at least one selected from the group consisting of a hair wig, a hairpiece, a weaving, a hair extension, a braid hair, a hair accessory, and a doll hair.
